(19) United States
(12) Patent Application Publication
(10) Pub. No.: US 2007/0256917 A1
(43) Pub. Date: Nov. 8, 2007

(54) Film Actuator Based Mems Device and Method

(76) Inventors: Joachim Oberhammer, Stockholm (SE); Goran Stemme, Stockholm (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/570,681

(22) PCT Filed: Sep. 9, 2004
(86) PCT No.: PCT/IB04/51732

§ 371 Date: Jan. 9, 2007

(30) Foreign Application Priority Data
Sep. 9, 2003 (SE) 0302437-9

(51) Int. Cl. H01H 59/00; H01H 11/00

(52) U.S. Cl. 200/181; 29/622

(57) ABSTRACT

The present invention discloses a Micro-Electro-Mechanical systems (MEMS) device suitable for use in a range of applications from DC, such as switching electrical signal lines, to RF applications such as tunable capacitors and switches. In an embodiment of the invention, the device comprises a bottom substrate and a top substrate separated at a fixed distance from each other. Disposed between the substrates is a flexible S-shaped membrane having an electrode or an electrically conducting electrode layer with one end attached to the top substrate and the other end in contact with the bottom substrate. An electrically conducting contact block is attached to the underside of the membrane actuator for short circuiting a signal line when the switch is in the closed position. When a voltage is applied between the membrane and an electrode layer on the bottom substrate, the membrane is induced by electrostatic force to deflect in a rolling wave-like motion such that the contact block is displaced into contact with the signal line. The device can be actively opened when a voltage is applied between the membrane actuator and a electrode layer on the top substrate causing the contact block to displace upward breaking contact with the signal line. The MEMS switching device is applicable for use in a switch matrix board for automatically switching telephone lines or in RF applications in the form of a tunable capacitor.

### FIELD OF THE INVENTION

The present invention relates generally to Micro-Electro-Mechanical systems (MEMS) switching devices and, more particularly, to an improved actuation means for said devices that enable for increased isolation characteristics while having lower actuating voltage requirements.

### BACKGROUND OF THE INVENTION

Interest in Micro-Electro-Mechanical systems (MEMS) devices has increased in recent years due of their potential to reduce costs through the economies gained from batch processing with significant reductions in device sizes. MEMS devices are very small mechanical devices fabricated with standardized integrated circuit technology, offering the advantages of high volume production with excellent uniformity in device properties over the whole wafer and over a whole batch of wafers. MEMS switches are devices that mechanically open (producing an open circuit) or closing to short-circuit a transmission line. Such switches are sub-millimeter in size and offer superior performance with high isolation and low insertion loss properties, with excellent signal linearity. Other benefits are that they provide better impedance matching with less frequency dependence, and have lower power consumption compared to conventional prior art electronic switches such as p-i-n diodes or GaAs FETs, for example. Because of these and other advantages MEMS switches have shown to be very desirable for use in applications with demands for high signal purity despite their relatively slow switching time in the microsecond range and having somewhat higher costs for implementing mechanical parts into electronic devices and related packaging.

A common form of actuation used in MEMS switches is electrostatic actuation. Electrostatic actuation induces movement of a switch element by creating a electrostatic force from electrostatic charges that build up from an applied voltage. Other actuation techniques include piezoelectric, electrostatic, pneumatic magnetic, and thermal bimorph actuation that uses dissimilar metals having different coefficients of thermal expansion that deform when heated to produce actuator movement. MEMS devices using electrostatic actuation have proved popular since they provide the advantages of lower power consumption and a simpler structure that allows for high process compatibility with semiconductor-based micro machining processes. However, some applications such as those requiring high electrical isolation characteristics are not suitable for use with conventional electrostatic actuation based MEMS devices. This is primarily due to the higher actuation voltages required to operate the device with correspondingly larger electrode distances used for higher electrical isolation between the contacts in the off-state.

FIG. 1 shows a prior art electrostatic metal contact switch in the open position or off-state that comprises an upper a cantilevered beam structure 110, actuation electrodes 120 and switching contacts 130 formed on a base substrate 100. The switch is closed when a voltage is applied between the actuation electrodes 120. The cantilevered arrangement uses a structure that is relatively stiff that helps to open the switch after the actuation voltage is removed. To obtain high electrical isolation in the off-state, the separation distance d1 between the line switching contacts 130 should be sufficiently large. On the other hand, this leads to a high DC voltage requirement to actuate the switch, since the electrostatic forces between the actuation electrodes 120 is proportional to 1/d₁, which is essentially the same as the distance between the line contacts 130. To maintain high electrical (or RF) isolation between the signal line at low contact distances the contact area is typically limited to dimensions of, for example, less than 500 μm² in order to minimize capacitive coupling which is directly proportional to the contact area. Although providing a large distance between the line contacts 130 leads to a high isolation in the off-state, the disadvantage is that the device also requires a high actuation voltage for overcoming the correspondingly larger distance d₁ between the actuation electrodes 120.

FIG. 2 shows the prior art electrostatic metal contact switch in the closed position or on-state. As mentioned, the voltages required to close the switch are relatively high when the actuation electrodes 120 are spaced far apart for improved electrical isolation between the switching contacts 130. By way of example, relatively high actuation voltages of 20-50V are required for some devices with contact distances on the order of only a few μm. Moreover, to open the switch, the cantilever structure must be relatively stiff to overcome the adhesion forces between the closed contacts, especially in the case of so-called “hot-switching” where a signal current is present when opening the contacts. The inherent stiffness of the structure undesirably increases the required actuation voltage needed to operate the device.

A conventional way to reduce the actuation voltage is to decrease the gap d1 between the switching contacts 130, however, problems with DC and RF isolation can arise to interfere with operation of the device. There have been improvements of this concept that use a push-pull configuration or a top counter electrode for reducing the actuation voltage requirements. However they still remain relatively high.

U.S. Pat. No. 5,380,396 describes a semiconductor fabricated gas valve using a bendable film element actuated by electrostatic force. The valve was designed for switching gasses of a large flow rate with high speed and accuracy. The valve uses a flexible film actuator that bends into position to divert the gas through a specific port depending on which direction the gas enters the chamber. Although relatively low actuation voltages can be achieved with the gas valve, there is no teaching or suggestion on how to adapt the arrangement to work as an electronic switching or RF capacitive tuning device.

In view of the foregoing, it is desirable to provide a MEMS switch design that mitigates the aforementioned disadvantages. The design of which can provide high operating efficiency by using low power low voltage actuation with high electrical isolation properties.

### SUMMARY OF THE INVENTION

It is an object of the present invention to provide a MEMS device that can be used in a wider range of applications by providing increased electrical isolation properties with relatively low actuation voltages.

Another object of the invention is provide a lower cost MEMS switching device that can be fabricated by processing methods where numerous devices can be produced in a highly paralleled process on a wafer or many wafers simultaneously to substantially reduce manufacturing costs.

It is another object of the invention to provide a high quality MEMS device that is highly replicable using standard semiconductor fabrication technology.

To achieve these and other objects, the invention provides a MEMS device suitable for use in a range of applications from DC, such as switching electrical signal lines, to RF applications such as tunable capacitors. In an embodiment of the invention, the device comprises a bottom substrate and a top substrate separated at a fixed distance from each other. Disposed between the substrates is a flexible S-shaped membrane having an electrode or an electrically conducting electrode layer with one end attached to the top substrate and the other end in contact with the bottom substrate. An electrically conducting contact block is attached to the underside of the membrane actuator for short-circuiting a signal line when the switch is in the closed position. When a voltage is applied between the membrane and an electrode layer on the bottom substrate, the membrane is induced by electrostatic force to deflect in a rolling wave-like motion such that the contact block is displaced into contact with the signal line. The switch can be actively opened when a voltage is applied between the membrane actuator and a electrode layer on the top substrate causing the contact block to displace upward breaking contact with the signal line.

In another embodiment of the invention, the MEMS device operates as a tunable capacitor.

In a further embodiment, the MEMS device is a device is incorporated in a switch matrix board for use in an automated cross-connect system for switching telephone lines in a telecommunication network.

### BRIEF DESCRIPTION OF THE DRAWINGS

The invention, together with further objectives and advantages thereof, may best be understood by reference to the following description taken in conjunction with the accompanying drawings in which:

FIG. 1 shows a prior art electrostatic metal contact switch in an open state;

FIG. 2 shows the prior art contact switch in an closed state;

FIGS. 3a-3c illustrates the MEMS switching device operating in accordance with a first embodiment of the invention in the open, intermediate, and closed positions respectively;

FIG. 4 shows a further embodiment of the invention using electrode clamps;

FIG. 5 shows a schematic perspective illustration of the exemplary fabricated switch in accordance with the invention;

FIG. 6 illustrates an overview of an exemplary fabrication process in accordance with an embodiment of the invention;

FIG. 7a shows a further embodiment for providing isolation;

FIG. 7b show still another embodiment of the invention showing an alternative device configuration;

FIG. 8 shows a diagrammatic illustration of an exemplary automated switch matrix board comprising the MEMS switches of the invention; and

FIG. 9 illustrates an exemplary depiction of an automated cross-connect system utilizing the MEMS switches of the present invention.

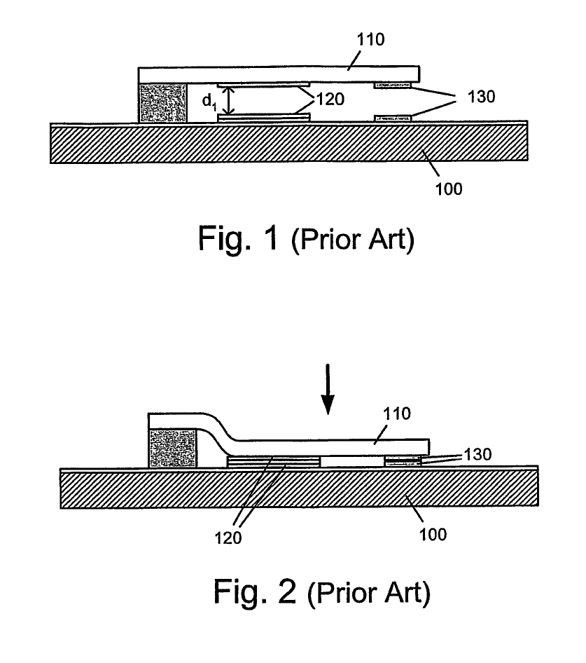

### DETAILED DESCRIPTION OF THE INVENTION

The present invention overcomes the disadvantages of the prior art electrostatic MEMS switches by providing the combined features of a large separation distance between the switching contacts while at the same time maintaining a relatively small gap between the actuation electrodes to enable a low actuation voltage for deflecting the membrane e.g. for opening or closing a switch.

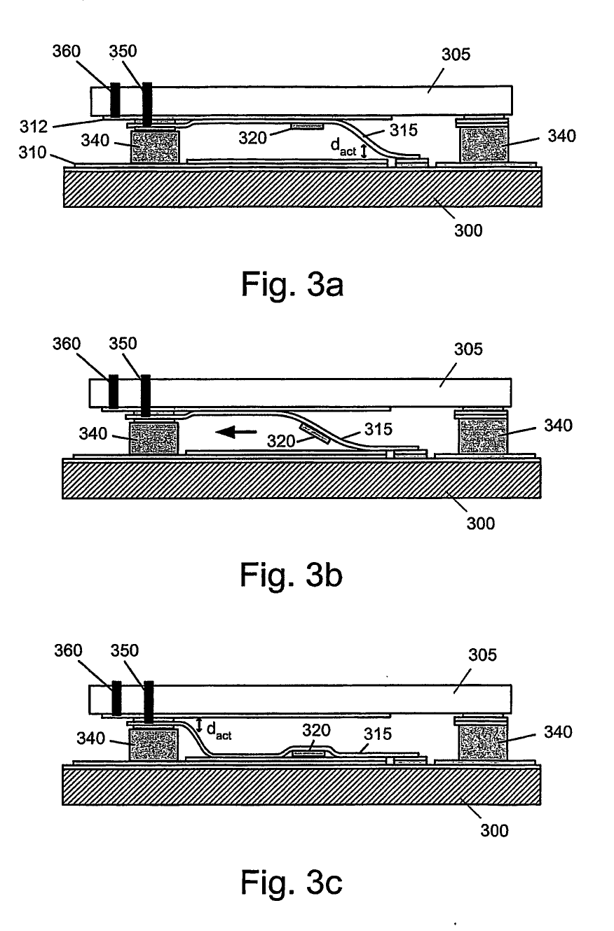

FIGS. 3a-3c illustrates an electrostatic MEMS switching device suitable for switching DC through RF signals operating in accordance with a first embodiment of the invention. The device comprises a thin flexible membrane 315, also referred to as an S-shaped membrane 315 having bottom and top electrodes 310 and 312 respectively and a metal contact block 320 mounted on the membrane 315 that is vertically deflectable between a bottom substrate 300 and a top substrate 305 separated by a small distance. The membrane 315 can be of a non-conducting material with an attached electrode and can itself be made from a flexible electrically conducting material or have a thin electrically conducting electrode layer attached to a surface of the membrane (not shown).

For displacing the membrane, the electrodes are in so-called touch-mode or ‘zipper-like’ actuation where the other end of the membrane 315 is in contact with the bottom substrate 300. This means that, where the initial actuation occurs, the membrane electrode and bottom electrode 310 are separated only by a very short distance d_{act}, which serves to conceptually illustrate a short vertical distance between the membrane electrode and the substrate electrode (or the top electrode when the membrane is pulled up). This conceptual distance is dependent on several factors such as e.g. the applied voltage and the angle of the membrane relative to the substrate surface and is not precisely defined. This short distance remains constant but continuously shifts to the left or right as the membrane 315 rolls to the left or right. As shown in FIG. 3a, a relatively large separation distance d, between the electrodes or line contacts can be achieved while the switch is in the open state.

FIG. 3b shows an intermediate state in the process of closing the switch. The actuator membrane 315 begins its rolling action when a voltage is applied between the membrane electrode and the bottom electrode 310.

FIG. 3c illustrates the fully closed state of the device where the film actuator has rolled down completely. In this state the metal contact block 320 is in electrical connection with the line electrode thereby causing a mechanical short-circuit of the line. To enable the contact block to make secure contact with the line there are electrodes located symmetrically around the contact block to ensure good contact.

To open the switch, the applied voltage to close the switch is released and a voltage is provided to the top electrode 312 via interconnection lead 360 that creates an electrostatic force between the top electrode and the membrane electrode via lead 350. It should be noted that the configuration of the interconnection leads shown in the figure is only exemplary for which the invention is not limited. It should be understood that other lead configurations are possible that will work successfully with various packaging designs and requirements. The preferred embodiment uses the double electrode principle to actively open and close the switch. However, it is possible to fabricate the membrane such that it contains an inherent stress that tends to keep the switch open. Thus to close the switch, a voltage to the bottom electrode is applied whereby releasing the voltage will cause the switch to open. This eliminates the need for a top electrode layer attached to the bottom surface of the top substrate 305.

For both cases, the electrodes are in so-called touch-mode actuation, i.e. the actuating parts of the electrodes are separated only by a very thin isolation layer (not shown) or the thin membrane itself. An advantage of the film actuator 315 is that it allows the displacement distance of the switching contacts, and thus the off-state isolation, to be independent of the effective electrode actuation distance. The decoupling of the relationship between the contact distance versus the actuation voltage greatly broadens the range of applications for electrostatically actuated MEMS devices. Thus, even at very low actuation voltages, high electrostatic attraction forces can be created inducing the membrane roll in a wave-like motion over the actuating counter-electrode, as shown in FIGS. 3b-3c.

The MEMS device of the invention provides with active-opening capability, where the membrane is pulled-up from an electrode layer attached to the top substrate, thus no spring energy is stored in the mechanical moving structure to open the switch. Consequently, the membrane can be made to be very thin and flexible which further lowers the actuation voltage. Due to the possible large distance between the line contacts in the off-state, the switching contact area may be designed substantially larger compared to prior art switch without decreasing the electrical isolation or inducing undesirable capacitive coupling. A larger contact area also lowers the contact resistance and the insertion losses, thus improving the current handling capabilities and implying less contact degradation.

Another advantage with the top electrode design is that a higher force can be created to open the switch, which allows switching during applied signal currents (“hot-switching”) with less risk of the switch sticking closed permanently due to contact microwelding occurring at a signal power greater than e.g. 20 dBm, for example. Moreover, stiction of the mechanical moving parts beside the metal contacts is less problematic due to the active restoring force created by a voltage applied between the membrane electrodes and the top electrodes. Thus, the total reliability of the switch can be substantially increased.

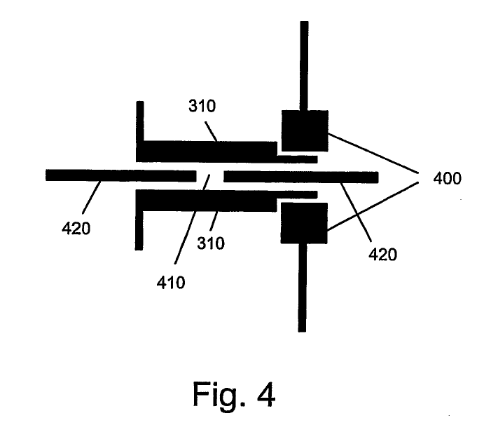

FIG. 4 shows a top view of the structure on the bottom substrate of the electrically active parts in accordance with a further embodiment of the invention. The arrangement can be implemented to keep the end of the membrane securely in “touch-mode” i.e. in close contact with the bottom electrode 310 during the off-state when the membrane is pulled up towards the top electrode 312. This ensures contact of the film to both electrodes in any state of the actuation. This is provided by use of additional electrostatic clamping electrodes 400 that clamps the membrane to the bottom substrate. A gap 410 provides a break in the signal line 420, which becomes electrically bridged when the contact block on the membrane is pressed against both sides of the signal line 420. In the case where both the top or bottom electrodes have an applied voltage i.e. membrane can be pulled toward the top or the bottom, the end of membrane must be affixed to the bottom substrate e.g. by the clamping electrodes to allow the membrane to function properly.

A potential applied to the clamping electrodes presses the ends of the membrane down to the bottom wafer, making it ready for “touch-mode” actuation between the membrane and the bottom electrodes for the next closing operation. The clamping is needed for safe operation of the switch and could be used to make initial contact between the membrane and the bottom substrate. For example, when the membrane has intrinsic stress to curl out-of-plane (of substrate) to provide contact with the bottom electrodes. For the full functionality of the electrostatic clamping mechanism, clamping electrodes are typically on the moving film and either on the bottom part or on the top part or on the bottom and top part. Furthermore, the clamping electrodes on the film might be connected to the film electrodes, or might be controlled independently of the film electrodes.

In the embodiment, the device uses more than two electrodes e.g. four electrode for its actuation: the top electrodes and the membrane electrodes also forming the membrane clamping electrodes on the top part of the switch, and the bottom electrodes and clamping electrodes on the bottom part. However, for operating the switch after start-up only the driving potential of one electrode must be altered and the other electrodes may be kept at a same potential.

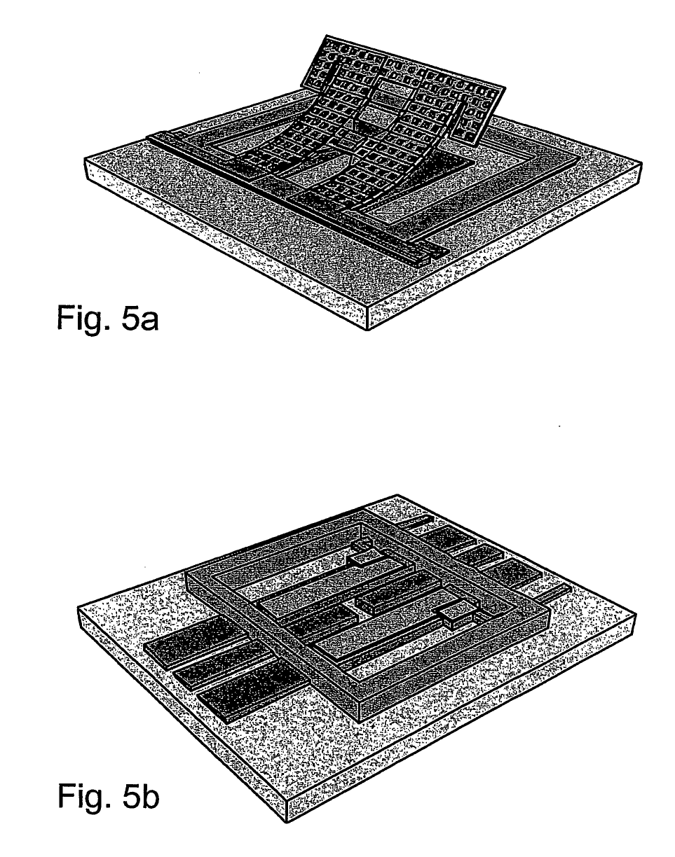

FIG. 5a and 5b show a schematic perspective illustration of the top and bottom substrates respectively of the exemplary fabricated device in accordance with the invention. As can be seen, the membrane actuator possesses an inherent curling stress that provides an advantageous downward tension force thereby eliminating the need the clamping electrodes. However, the clamping electrodes are typically used to insure that the film actuator is affixed to the substrate in touch-mode to provide proper operation of the film actuator during successive opening and closing cycles. Without clamping electrodes, the switching membrane could be pulled up completely towards the top electrodes in the off-state, and the switch could not be closed again should the membrane stick to the top electrodes even despite releasing the top electrode actuation voltage.

The fabrication of the device involves a two-part process that provides the advantage that the switch can easily be integrated with RF substrates of different materials without special restrictions in process compatibility of the MEMS part to the RF circuits, for example. Having an RF part and a MEMS part processed on separate wafers is a factor that contributes to increasing the yield of the device fabrication as a whole. The transfer of the switch might be done either by pick-and-placing of single devices or by full-wafer bonding using a patterned adhesive layer. Furthermore, this assembly concept leads to a near-hermetic package integrated switch, thus addressing one major problem of MEMS devices demanding an individual and complicated packaging solution.

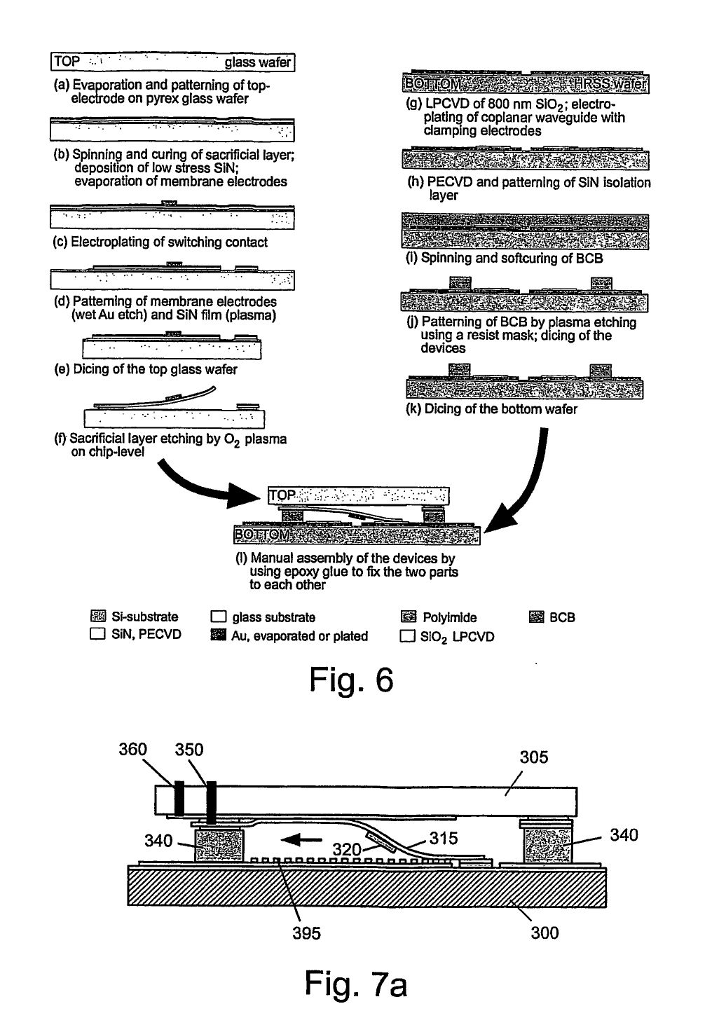

FIG. 6 illustrates an overview of an exemplary fabrication process for use in microfabricating the MEMS device of the invention. It should be noted that the fabrication process and the dimensions given are exemplary and that variations in the processing steps or the addition or elimination of steps are possible due to technological advances. Moreover, any or all of the steps may be automated using commercially available equipment. The design uses a total of seven photolithography masks. Three of them are used for the bottom part and the other four for the top part of the switch. All the processes involved in the fabrication of the two parts are standard clean-room surface-micromachining processes with a maximum temperature budget of 350° C. for the MEMS part of the switches. The basic fabrication procedure is schematically illustrated in the figure and further explained in more detail in the following paragraphs.

Top Wafer (Switching Structure)

A 150 nm thick gold layer with a 40 nm thick chromium adhesion layer is evaporated onto the glass substrate to form the top electrodes. This layer is patterned subsequently by wet etching (FIG. 6(a)). Then, polyimide Pyralin PI 2555 from HD MicroSystems is spun with a thickness of 1.5 μm onto the wafer. The imidization of the polymer, which is used as sacrificial layer to release the membrane, occurs already at 180° C. However, it has to be fully cured at 350° C., since its curing temperature should be higher than any of the subsequent processing temperatures to avoid outgassing at a later fabrication step. Then, the 1 μm thick silicon nitride membrane layer is deposited by low-stress PECVD at 300° C., using dual-frequency RF power. Afterwards, a 40 nm/150 nm thick chromium/gold layer is evaporated (FIG. 6(b)). This layer acts as seed layer for the following electroplating and is also used for the membrane electrodes with their membrane clamping electrode parts. The 2 μm thick gold switching contact is electroplated using a Clariant AZ4562 photoresist mask (FIG. 6(c)). After removing this resist mask, the chromium/gold layer is patterned by wet chemistry. Then, the silicon nitride layer is etched down to the polyimide layer in a RIE tool using CF4 plasma (FIG. 6(d)). The devices are cut by a die saw (FIG. 6(e)) before etching the sacrificial layer, which is done in O2 plasma at a power of 1000 W and a pressure of 100 mTorr (FIG. 6(f)).

Bottom Wafer (Signal and Control Lines)

A 800 nm thick silicon dioxide layer is deposited by LPCVD onto the high resistivity silicon wafer as an isolation layer. Then, a chromium/gold layer with a thickness of 40 nm/150 nm, acting as seed layer for the subsequent electroplating, is evaporated onto the wafer. The coplanar waveguide is created together with the clamping electrodes by electroplating of 2 μm of gold in an alkaline, non-cyanide, thallium based gold bath (FIG. 6(g)). AZ 4562 photoresist from Clariant is used as a masking layer for the plating. The seed layer is etched away by a kalium iodid solution after removing the photoresist mask in aceton. A 200 nm thin silicon nitride layer is deposited onto the wafer by low temperature PECVD. The adhesion of the silicon nitride layer to the plated gold was found to be very poor and the nitride layer just pealed off when the photoresist for patterning the layer was removed in acetone. An oxygen plasma treatment at 1000 W for 10 minutes immediately before the CVD improves the adhesion substantially. The silicon nitride layer is patterned by photolithography followed by reactive ion etching (RIE), using CF4 plasma, and forms the isolation layer on top of the bottom electrodes (FIG. 6(h)). Afterwards, the ring-shaped wall outlining the switch cavity is created using Benzocyclobutene (BCB) of the 3022-series from the Dow Chemical Company. This polymer is spun onto the wafer with a thickness of 18.2 μm (FIG. 6(i)). It is hard-cured at 280° C. and then patterned by photolithography using a thick photoresist mask and by etching in a RIE tool using CF4/O2 plasma, as shown in FIG. 6(j). Finally, the wafer is cut by a die saw (FIG. 6(k)).

Device Assembly

The switch can be assembled on wafer level using a commercial substrate bonder, fully curing the BCB distance ring during the bonding procedure. The two parts are manually aligned with an accuracy of approximately 20 μm. The alignment procedure is relatively simple since glass was chosen as substrate for the top part of the switch. Thus, the two towards each other facing structures are visible through the glass substrate. Despite the fact that the tips of the membranes are in contact with the bottom substrate during the alignment involving small lateral moments between the two parts, the membranes are not damaged by the procedure. Furthermore, a full wafer alignment in a substrate alignment tool was found to be not critical since the bending of the membrane does not exceed more than about 200 μm which is in the range of the programmable distance between the wafers in commercially available mask/substrate aligners during the loading and the initial approaching of the wafers in the tool. After careful alignment, the parts are fixated to each other by e.g. wafer bonding.

In the embodiment, the film actuator is a silicon nitride actuator membrane is on the order of 900 μm long and 1 μm thick giving a ratio of length to thickness of roughly 900 to 1. It should be noted that the dimensions given are only exemplary and that sizes can vary significantly for the elements when fabricating the device. Polyimide is used as a sacrificial layer to release the membrane. A dry-etchable sacrificial layer was chosen to avoid stiction of the very flexible membrane to the substrate. For the release-etch, sacrificial layer etch-holes are placed all over the membrane with a distance between the holes.

The switch might be fabricated on a substrate of any kind of material (e.g. silicon, gallium-arsenide, quartz) or on ceramic carriers. Moreover, the switch might be fabricated completely on one substrate, or the top and the bottom part might be fabricated on a different substrate and finally assembled, either manually or by an automated process such as by flip-chip-bonding or wafer bonding, for example. With regard to the actuator, the film can be either processed on the top part, on the bottom part or independent of the top and bottom parts on separate substrates and then transferred to either the top or the bottom part.

In a further embodiment of the switch, the end of the membrane could be brought initially in contact or to close approximation to the bottom substrate electrode either by 1) the intrinsic curling stress in the membrane 2) or by the curling stress and electrostatic attraction of the membrane from e.g. the electrostatic clamps 3) or by electrostatic clamping alone.

In a further embodiment, the switch comprises one or more electrical isolation layers between the electrodes; either on top of the top and/or bottom electrodes or on the moving film. The isolation layers can be of any kind of non-metallic materials like polymers or ceramics. An isolation layer on the film might also have structural function to improve the mechanical stability of the film.

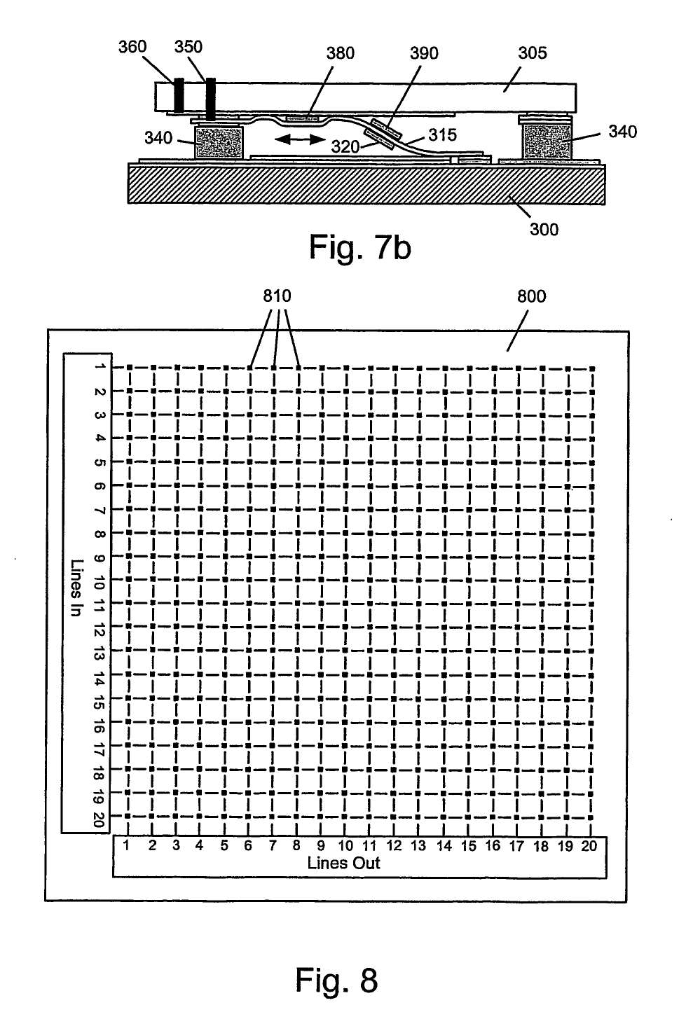

FIG. 7a shows a further embodiment where the device can provide isolation of the electrically active parts without using conventional isolation layers. By way of example, isolation of the membrane electrode from the substrate electrode can be achieved by using a plurality of pillars 395 to support the membrane 315 when is lays down on the substrate. The pillars themselves can be metal or any other material. With metal pillars 395, isolation is achieved by positioning the pillars in recesses or holes in the substrate material such that they are electrically isolated from other electrically active components.

In the preferred embodiment, distance keeper structures 340 are implemented to maintain the distance between the top and the bottom part and can consist of any kind of metallic, organic or non-organic material. In a preferred embodiment, the distance keepers 340 enclose around the switch e.g. in the formation of a square ringed wall. The distance keeper walls enclosing the device, when sandwiched between the top substrate and the bottom substrate, gives an added benefit of providing an initial level of encapsulation for packaging the switch. However, the distance keepers can be structural pillars that are independent of the encapsulation. By way of example, they can be separate pillars that are selectively positioned around the device supporting to support the separation of the substrates that can be located inside the encapsulated package.

With regard to packaging, the embodiment can use vertical electrical interconnection lines through the bottom or the top part or the bottom part and the top part of the switch to electrically access the top part/the bottom part/the top and the bottom part from the back-side of the substrate used for the top part/bottom part/top and bottom part. The switch can be packaged in any atmosphere suitable for its operation that could include an electronegative atmosphere or any other gas or gas mixture. Moreover, the pressure inside the package might be any degree of vacuum, normal pressure or over-pressure.

In another embodiment of the invention relating to RF applications, the design of the switch is made in a way that the mechanical moving (MEMS) part of the switch is processed on a separate substrate than the transmission line. The target substrate to which the mechanical part of the switch is transferred, contains at the basic level only the signal transmission line, the bottom clamping electrodes, and the polymer ring-wall forming the cavity for the switch and defining the distance between the two parts of the switch after the final assembly.

The invention applies to other types of MEMS devices in addition to series switches such as tunable capacitors used in tuning the signal line, for example. The tunable capacitor is essentially the same device described without the contact switching element on the membrane. The device forms the capacitor by having the a conductive layer attached to the membrane surface to effectively form one plate of the capacitor having one charge. The other plate having an opposite charge is effectively formed from the conductive layer on the bottom or top substrate, which can act as the bottom electrode. Both the top and bottom electrodes are used to control the position of the membrane.

In a related further embodiment, the device can be configured for two tunable capacitors in the same device operating simultaneously where one capacitor is defined between the bottom surface of the membrane and the bottom substrate and the other between the top surface of the membrane and the top substrate. The membrane singly controls the capacitance of both capacitors in a manner where the bottom capacitor is increased while the top capacitor is decreased and vice versa.

To act as a tunable capacitor, the area of the plates is effectively varied by rolling the membrane in the manner described in the invention. For example, the capacitance can be reduced by rolling to the left membrane down toward the bottom substrate and vice versa to increase the capacitance. In this tunable capacitor application, a control circuit is used to precisely control the amount of roll for the membrane by controlling the voltage between the electrodes. Furthermore, a feedback system utilizing a sensor to determine the current capacitance or position of the membrane can be implemented. Some examples of applications include tuning filters and for matching line impedance in RF transmission lines.

In shunt switch, the isolation properties is very small at lower frequencies due to its capacitive short-circuiting principle but its performance is much better at higher frequencies in the millimeter wavelength range, for example. Typical applications for the capacitive MEMS switches include those uses in the field microwave radar and other high frequency RF applications.

FIG. 7b show still another embodiment of the invention where the MEMS device is configured to provide switching in both directions i.e. when the membrane is in the up or down position. Here a further line connection can be made when the membrane is up causing contact block 380 to come in contact with a line electrode on the bottom surface of the top substrate 305. At the same time the switch is off for the line on the bottom substrate 300. Furthermore, multiple contact blocks such as 390 can be attached to either side of the membrane to provide further switching alternatives. Similarly, a further embodiment includes having multiple capacitive shunt switches where the individual capacitors defined between the membrane and the substrate electrodes operate separately. Some examples of applications include switching telephone line pairs, and Single Pole Double Through (SPDT) applications where a single input can be switched to one of either two outputs that are located on the bottom and top substrate respectively.

Further embodiments can include reversing the arrangement of the membrane e.g. by having one end attached to the bottom substrate instead of to the top substrate with the other end either in contact with the top substrate, either by clamping or in “touch-mode” from curling stress.

The MEMS devices of the type, as described by the invention, are applicable to switching equipment used in telecommunication networks and, in particular, in automated switch matrices for cross-connecting line pairs with automated cross-connect equipment.

In a typical telecommunication network, the central office houses a telephone exchange to which subscriber home and business lines are connected to the network on what is called a local loop. Many of these connections to residential subscribers are typically made using a pair of copper wires, also referred to as a twisted pair, that collectively form a large copper network operated by the telecom provider. Within the central office the line connections between the exchange side and the subscriber side are terminated at a main distribution frame (MDF), which is usually the point where cross-connections between the subscriber lines and the exchange lines are made. Virtually all aspects of the telecommunication network are automated with the notable exception of the copper network. Management of the copper infrastructure, e.g. connecting and disconnecting telephone service from a subscriber, is a highly labor intensive process that results in one of the most significant costs faced by telecommunication providers. The reason is that the central office traditionally must dispatch a technician to the MDF site to manually install cross-connects using jumper wires or to analyze or test the lines in the copper network. As a result service providers have long desired to implement automated cross-connect systems in their telephone networks to reduce costs and improve reliability.

FIG. 8 shows a diagrammatic illustration of an exemplary automated switch matrix board 800 incorporating a plurality of MEMS film actuator switches 810 of the present invention. The MEMS switches are microfabricated into the switch matrix board thereby reducing the manufacturing costs significantly. In an exemplary embodiment, the switch matrix board has the capacity to handle switching of any of the 20 input line pairs to any of the 20 output line pairs. It should be noted that the capacity of the switch matrix shown is exemplary and that significantly variations are possible since the switches are on a micrometer scale it is possible to incorporate very large numbers into the boards.

In the embodiment, the switch matrix boards are incorporated into cross-connect boards that are inserted into the termination blocks in the MDF in a modular fashion. By way of example, a cross-connect board is inserted into the slot of the KRONE LSA-Plus termination blocks that are commonly used in many central office MDFs. The skilled person in the art will appreciate that the described cross-connect boards can be adapted to mate with different configurations of termination blocks with relatively minor modifications to the connector arrangement. The interconnected modular cross-connect boards are included as part of a cross-connect system installed in distribution frame locations within a telecommunication network to provide remotely automated cross-connect functionality, such as in the Nexa™ automated cross-connect system manufactured by Network Automation AB of Stockholm, Sweden.

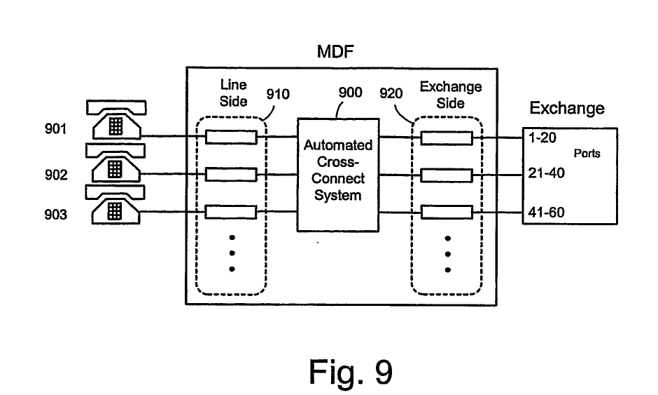

FIG. 9 is an illustration of the automated cross-connect system installed within an exemplary telephone network and operating in accordance with the invention. The automated cross-connect system 900 enables so-called any-to-any connections from any of the subscriber line pairs to any physical (or logical) port on the exchange. By way of example, subscriber lines (901, 902, 903) are connected at the MDF via connector blocks 810 on the line side. The output lines from connector blocks 910 are coupled to the cross-connect system 900, which establishes on demand cross-connections to any of ports on the central office exchange via the exchange side connector blocks 920. The switch matrix connector boards are connected to the connector blocks and interfaces with the cross-connect system. By way of example, when a command is given to the system to make, remove or modify a cross-connect, the corresponding MEMS switch associated with a selected line on the switch matrix board is automatically actuated by the system software.

The foregoing description of the embodiments of the invention has been presented for purposes of illustration and description. It is not intended to be exhaustive or to limit the invention to the precise forms disclosed, since many modifications or variations thereof are possible in light of the above teaching. Accordingly, it is to be understood that such modifications and variations are believed to fall within the scope of the invention. The embodiments were chosen to explain the principles of the invention and its practical application, thereby enabling those skilled in the art to utilize the invention for the particular use contemplated. Still the invention is not limited to the specific applications shown instead it can be used with a wide range of applications from DC to radio frequency applications. It is therefore the intention that the following claims not be given a restrictive interpretation but should be viewed to encompass variations and modifications that are derived from the inventive subject matter disclosed.

1. A MEMS device comprising:
a first substrate;
a second substrate disposed over the first substrate such that a separation distance is maintained between the substrates;
a flexible membrane disposed between the first substrate and the second substrate, wherein a first end of the membrane is in contact with the first substrate and a second end is attached to the second substrate;
at least one electrically conducting element on the membrane for interacting with at least one electrically conducting component on one of the substrates; and
an actuation electrode attached to at least one of the substrates and at least one actuation electrode attached to the membrane for providing electrostatic force to mechanically operate the actuator to cause the membrane to displace in a rolling wave-like motion such that the electrically interacting element(s) on the membrane are displaced in a manner that interacts with the at least one electrically conducting component on one of the substrates.

2. A MEMS device according to claim 1 wherein, the actuation electrodes are on both the first substrate and the second substrate to provide a pull-pull capability for deflecting the membrane to actively move it in both directions.

3. A MEMS device according to claim 1 wherein, one end of the membrane is mechanically attached to either the first or second substrate.

4. A MEMS device according to claim 3 wherein, the one end of the membrane is attached by means of mechanical electrostatic clamping.

5. A MEMS device according to claim 1, one end of the membrane is in contact with one of the substrates caused by the shape of the membrane from built-in intrinsic stress.

6. A MEMS device according to claim 1 wherein, the interaction between the electrically conducting element on the membrane and one of the substrates produces a metal-contact series switch, a metal-contact shunt switch, a capacitive series switch, a capacitive shunt switch, or a tunable capacitor.

7. A MEMS device according to claim 1 wherein, one or more electrical isolation layer(s) are attached between the electrodes, either between the bottom electrode and/or top electrodes attached to the first and/or second substrates respectively or on the membrane, wherein the isolation layers can be constructed from any type of non-metallic material such as polymers or ceramics.

8. A MEMS device according to claim 1 wherein, electrical isolation between the membrane and the electrically active parts on the substrate is provided by a plurality of pillars located in recesses in the substrate.

9. A MEMS device according to claim 1 wherein, the separation distance between the first substrate and the second substrate is provided by separation structures such as pillar located at selective points around the device.

10. A MEMS device according to any claim 1 wherein, the separation structures is effectively a wall encircling the device such that the first and second substrates sandwich the wall to encapsulate the device and provide a level of packaging for the device.

11. A MEMS device according to claim 10 wherein, the device is packaged in an atmosphere suitable for its operation such as an electronegative atmosphere or other gas or gas mixture atmosphere, and wherein the pressure inside the package comprise any degree of vacuum, normal pressure or over-pressure.

12. A MEMS device according to claim 1 wherein, the membrane is fabricated to have an intrinsic stress that tends to move the end of the membrane towards the opposing substrate from which the membrane is attached, and wherein the stress causes the membrane to lift toward the substrate from which it is attached when the actuation voltage is released.

13. A method of operating a MEMS switching device comprising a first substrate and a second substrate disposed over the first substrate such that a separation distance is maintained between the substrates, a flexible membrane having an actuation electrode disposed between the first and second substrates, wherein a first end of the membrane is in contact with the first substrate and a second end is attached to the second substrate, at least one electrically conducting element on the membrane for interacting with at least one electrically conducting component on one of the substrates, a control electrode on at least one of the substrates, comprising the step of:
applying a voltage between the actuation electrode and the actuation electrode for providing electrostatic force to mechanically operate the actuator to cause the membrane to displace in a rolling wave-like motion such that the electrically interacting element(s) on the membrane are displaced in a manner that interacts with the at least one electrically conducting component on one of the substrates.

14. A method according to claim 13 wherein, the membrane is actively moved toward the first or second substrate by applying a voltage between the membrane electrode and control electrodes attached to both the first and second substrates.

15. A method according to claim 13 wherein, the membrane provides a force from intrinsic stress that tends to move the end of the membrane towards the opposing substrate from which the membrane is attached, and wherein the stress causes the membrane to lift toward the substrate from which it is attached when the actuation voltage is released.

16. A method according to claim 13 wherein, the first end of the membrane is secured to the one of the substrates with electrostatic clamping electrodes by applying a voltage to the clamping electrodes.

17. A process for microfabricating a MEMS device comprising the steps of:
forming electrically active components on a first substrate;
forming isolation layers on the first substrate for isolating some of the electrically active components;
forming separation(s) structures on the first substrate;
forming electrically active components on the second substrate;
forming a sacrificial layer on the second substrate;
forming a flexible membrane having electrically active components on the second substrate;
releasing parts of the membrane by etching parts of the sacrificial layer on the second substrate; and
assembling the device by affixing the first substrate to the second substrate to form a complete device unit.
